(19) United States
(12) Patent Application Publication
(10) Pub. No.: US 2011/0185313 A1
(43) Pub. Date: Jul. 28, 2011

(54) METHOD AND SYSTEM FOR CUSTOMIZING A USER-INTERFACE OF AN END-USER DEVICE

(76) Inventors: IDAN HARPAZ, Tel Aviv (IL); Ben Hirsch, Ra'anana (IL)

(21) Appl. No.: 13/013,932

(22) Filed: Jan. 26, 2011

Related U.S. Application Data
(60) Provisional application No. 61/298,256, filed on Jan. 26, 2010.

(51) Int. Cl. G06F 3/048

(52) U.S. Cl. 715/826

(57) ABSTRACT

A mobile device includes a storage unit and an add-on user experience engine. The storage unit stores an instruction table which defines at least one contextual menu which is associated with multiple applications of the mobile device according to the context. The add-on user experience engine parses the instruction table and displays the at least one contextual menu with at least one button. Each button accesses one of the applications with parameters for the application as defined in the instruction table. A user experience menu definer includes an authorizer to provide an authorized individual with access to information about a mobile device of another person and a table defining unit which generates the instruction table from input of the authorized individual.

### CROSS-REFERENCE TO RELATED APPLICATIONS

This application claims benefit from U.S. Provisional Patent Application No. 61/298,256, filed Jan. 26, 2010, which is incorporated herein by reference in its entirety.

### FIELD OF THE INVENTION

The present invention relates to a user-interface for mobile communications devices generally and to such an interface for mobile telephones in particular.

### BACKGROUND OF THE INVENTION

As mobile telephones become more sophisticated and offer more and more options their user interfaces become increasingly complex. This, combined with the fact that miniaturization of mobile telephones results in the keypad becoming ever smaller, imposes a major hardship on the aged and infirm. Additionally, young children and other groups require a specialized and focused user experience different from that available from the standard user interface.

The present generation of mobile telephones offers a partial solution to this problem by provision of a virtual keyboard, whereby a limited number of keys is presented on the telephone display, which operates as a touch screen. These keys, being significantly larger than those of the keypad, are much easier to navigate, particularly for older people.

Virtual touch-screen keypads for mobile telephones are known. For example, Opera Mobile™ provides a unified interface for mobile feature phones and smartphones that allows mobile Web browsing for mobile telephones from different manufacturers and operators, such as T-Mobile, Samsung, Motorola and HTC.

Likewise, customization of mobile telephone interfaces is known. For example, US2009/0063179, published Mar. 5, 2009, discloses a user interface customizing system for an electronic device e.g. a mobile phone, wherein a transmitting module uploads a software package to a designated location for being downloaded by a terminal device. According to one embodiment, a request for customizing a user interface is sent from a terminal device to a server, which acquires configuration data on a current user interface of the terminal device, and based thereon, creates a customized user interface software and installation software in a software package, which it uploads to a designated location from where it is downloaded to the terminal device for installation by executing the installation software.

US2008/0215999 discloses a method for customizing a user interface, wherein a user optionally sets a user interface displayed on a display unit of a mobile telecommunication terminal according to the user's tastes, such that a background screen image selectable by a user, which constitutes the user interface, is placed as a backdrop, and a menu image is overlapped on the background screen image in a transparent or semi-transparent double structure.

These references relate particularly to replacement of the complete user interface so that the device can be customized for use with different operating systems. By such means, a mobile telephone of one manufacturer can emulate that of a different manufacturer. There is no suggestion in any of these prior art references to allow only partial customization or re-configuration of a user interface.

Jitterbug™ provides a mobile telephone having large buttons that are more easily seen and manipulated by the elderly or technically-challenged user so as to provide easy access to a personal Phone Book, with the names and numbers of frequent contacts being updatable on-line. This and other current trends are discussed in Next generation wireless applications: creating mobile applications in a Web by Paul Golding, also available on-line.

Various approaches to efficient downloading of software and operating systems are also known, such as those of Redbend™ (see http://www.redbend.com/) and TAT™ (see http://www.tat.se/site/showroom/latest_design.html), which appear to show touch screen customizable features which relate to changes to the operating system or communication data such as roaming tables.

### SUMMARY OF THE INVENTION

There is therefore provided, in accordance with a preferred embodiment of the present invention, a mobile device which includes a storage unit and an add-on user experience engine. The storage unit stores an instruction table, the instruction table defining at least one menu which is associated with multiple parameter receiving applications of the mobile device. The add-on user experience engine parses the instruction table and displays the at least one menu with at least one button, wherein each button is configured to activate one of the applications with parameters for the application as defined in the instruction table.

Moreover, in accordance with a preferred embodiment of the present invention, the device also includes a downloader to receive the instruction table from a web server accessible to an authorized individual.

Further, in accordance with a preferred embodiment of the present invention, each of the buttons is responsive to the instructions for operating as any one in the group of: a menu button, a telephone dialing button calling a specific number, an information request button an emergency call button and a remote-control button.

Still further, in accordance with a preferred embodiment of the present invention, the device also includes a button unit to store a history of usage of the buttons.

Additionally, in accordance with a preferred embodiment of the present invention, the device also includes an uploader to upload the history to the web server for analysis.

Moreover, in accordance with a preferred embodiment of the present invention, the remote-control button is configured to communicate with a warning device located in the premises of the authorized individual.

Further, in accordance with a preferred embodiment of the present invention, the instruction table defines a menu hierarchy arranged in a tree-structure defining multiple records, each of which defines a stage in the menu tree, with each button shown serving either to call another branch of the menu record, or to activate an application associated with that button.

Still further, in accordance with a preferred embodiment of the present invention, the user experience engine comprises unit to access and interpret a master record defining the top level menu on actuation of the mobile device.

Moreover, in accordance with a preferred embodiment of the present invention, the master record defines a number of hot buttons for which pre-stored legends or icons are shown on actuation of the mobile device.

Further, in accordance with a preferred embodiment of the present invention, at least one of the hot buttons serves to allow navigation through the menu tree.

Still further, in accordance with a preferred embodiment of the present invention, each application comprises an engine to receive at least button press code providing parameters to internal functions of the application.

There is also provided, in accordance with a preferred embodiment of the present invention, a user experience menu definer implementable on a web server. The definer includes an authorizer and a table defining unit. The authorizer provides an authorized individual with access to information about a mobile device of another person. The table defining unit generates an instruction table from input of the authorized individual, where the instruction table defines at least one menu which is associated with multiple parameter receiving applications of the mobile device. The table also defines buttons per menu, wherein each button is configured to activates one of the applications with parameters for the application.

Moreover, in accordance with a preferred embodiment of the present invention, the definer also includes a communicator to receive a history of usage of the buttons to a database server.

Further, in accordance with a preferred embodiment of the present invention, the definer also includes an analyzer to analyze the history.

Still further, in accordance with a preferred embodiment of the present invention, the analyzer includes a button updater to update a functionality of the buttons.

Moreover, in accordance with a preferred embodiment of the present invention, the communicator includes a unit to send an alert to one of the authorized individuals based on output of the analyzer.

Further, in accordance with a preferred embodiment of the present invention, the table of instructions includes a menu hierarchy arranged in a tree-structure defining multiple records, each of which defines a stage in the menu tree, so that when uploaded by the communicator to the mobile device each button shown thereby serves either to call another branch of the menu record, or activate a function associated with that button.

Still further, in accordance with a preferred embodiment of the present invention, the database server stores for each mobile device a respective master record defining a top level menu to be accessed and interpreted on actuation of the mobile device.

Moreover, in accordance with a preferred embodiment of the present invention, the master record defines a number of hot buttons for which pre-stored legends or icons are shown on the touch-screen on actuation of the mobile device.

Further, in accordance with a preferred embodiment of the present invention, at least one of the hot buttons serves to allow navigation through the menu tree.

There is also provided in accordance with a preferred embodiment of the present invention, a method for a mobile device. The method includes storing an instruction table, the instruction table defining at least one menu which is associated with multiple parameter receiving applications of the mobile device, parsing the instruction table and displaying the at least one menu with at least one button, wherein each button is configured to access one of the applications with parameters for the application as defined in the instruction table.

There is also provided in accordance with a preferred embodiment of the present invention, a method implementable on a web server. The method includes providing an authorized individual with access to information about a mobile device of another person, from instructions of the authorized individual, generating an instruction table defining at least one menu which is associated with multiple applications of the mobile device, the table defining buttons per menu, wherein each button is configured to activate one of the applications with parameters for the application.

Finally there is provided, in accordance with a preferred embodiment of the present invention, a mobile device which includes a processor and a touch-screen interface. The processor is coupled to a memory for operating in accordance with communications and human-interface software stored in the memory. The touch-screen interface is coupled to the processor and is responsive to the software for displaying a virtual keypad having programmable buttons, at least some of which are configured to operate in accordance with stored instructions that are downloadable to the device so as to provide a respective software function. The instructions includes a menu hierarchy arranged in a tree-structure defining multiple records, each of which defines a stage in the menu tree, with each button shown serving either to call another branch of the menu record, or to activate a function associated with that button.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of an exemplary mobile device having an add-on user experience engine, constructed and operative in accordance with a preferred embodiment of the present invention;

FIG. 2 is a schematic illustration of the preparation of an instruction table, useful for the engine of FIG. 1;

FIG. 3 is a schematic illustration of the preparation of the instruction table of FIG. 2 on a web server;

FIG. 4 is a schematic illustration of the elements of the web server of FIG. 3; and

FIG. 5 is a schematic illustration of the elements of a user interface application to be called from the engine of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that there is a need to simplify the user interface of a mobile telephone, or make it more relevant by displaying only those features or functionalities that are of interest to the end-user, particularly for end-users not interested in the complex features available.

Applicants have also realized that there is a need to provide features by context rather than by function where multiple functions may be grouped within a theme, each one being activated according to the theme. For example, aged, physically impaired, and young children, who typically require little more than the ability to dial a small number of contacts and, possibly, a small number of other options, may have the functions they need grouped according to themes.

Applicants have further realized that each user may have different abilities and different needs which may also change over time. Thus, the ability to change the user interface as these functional needs evolve is important as is the ability to control this interface remotely, thereby limiting and defining the functionality available.

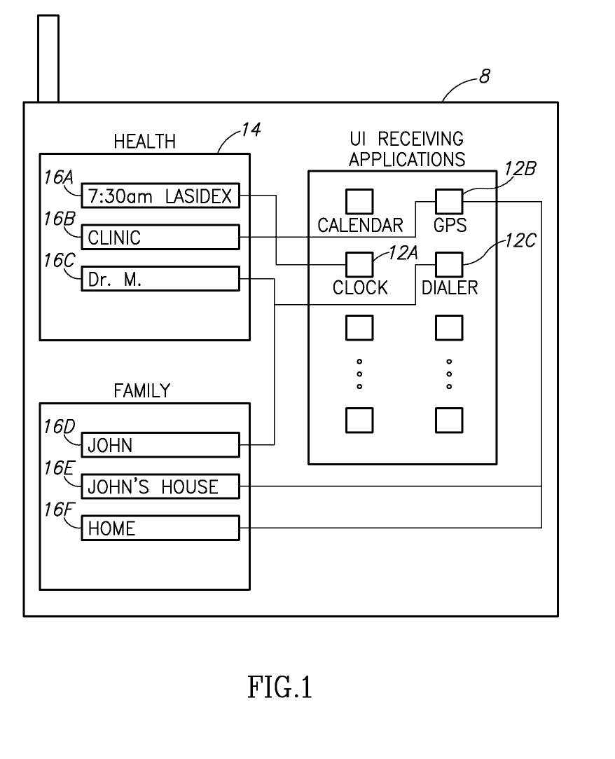

Reference is now made to FIG. 1, which is a schematic illustration of the operation of a mobile telephone 8, operative in accordance with a preferred embodiment of the present invention. Mobile telephone 8 may comprise a plurality of user interface (UI) receiving applications 12, of which, for clarity, only 10 are shown, it being appreciated that a mobile telephone may typically have more.

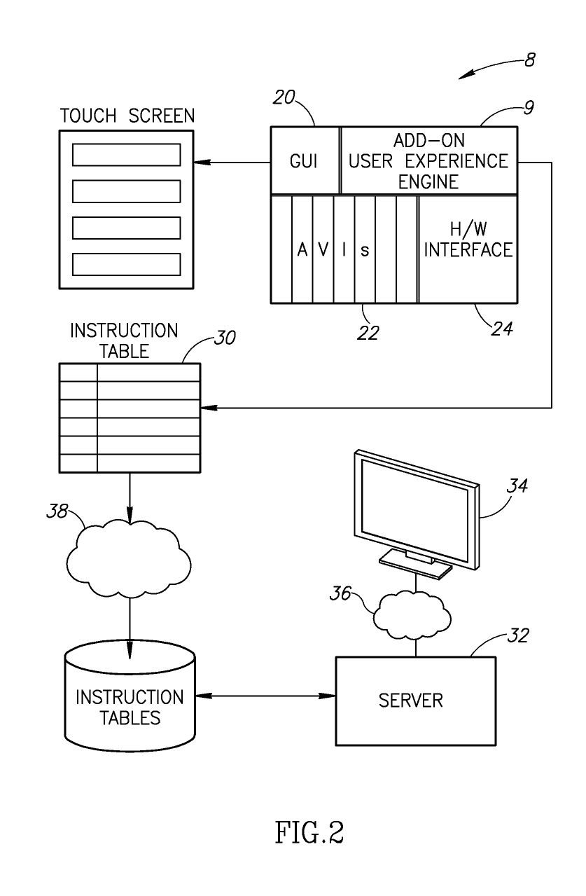

In accordance with a preferred embodiment of the present invention, mobile telephone 8 may comprise an add-on user experience engine 9 (detailed hereinbelow with respect to FIG. 2) which may provide a multiplicity of contextual menu elements 14 to mobile telephone 8, where FIG. 1 shows two contextual menu elements 14. In accordance with a preferred embodiment of the present invention, each menu element 14 accesses a different set of applications 12. Alternatively, contextual context menu elements 14 may access the same set of applications 12 but with different parameters.

Each contextual menu element 14 may have buttons 16 which may either access a sub-menu within the context or may provide an action according to the context. For simplicity, FIG. 1 illustrates menu elements 14 which only provide actions. For example, the two contexts or themes might be Health and Family. Button 16A, which may be labeled “7:30 am Lasidex”, may access a clock application 12A with a reminder at 7:30 am and a reminder label of Lasidex or with a photograph of the Lasidex pill. Button 16B may be labeled “Clinic” and may access a GPS application 12B with the address of the clinic. Button 16C may be labeled Dr. M. and may access a phone dialer 12C with Dr. M's phone number. Other buttons may show other health-related elements, such as photographs of any medicines and of any relevant medical people, an emergency phone number, and access to a book about first-aid.

In contextual menu element 14B, button 16D may be labeled “John” and may access phone dialer 12C with John's phone number. Button 16E may be labeled John's house while button 16F may be labeled Home. Both may access GPS application 12B but button 16E may provide John's address while button 16F may provide the user's home address.

It will be appreciated that there may be multiple contextual menu elements 14, all of which may be organized in a hierarchy from a main menu element. It will further be appreciated that, as described hereinbelow, applications 12 may be novel applications capable of receiving parameters from user experience engine 9.

Reference is now made to FIG. 2, which is an overall schematic diagram of a preferred embodiment of the system of the present invention. Add-on user experience engine 9 may be downloaded to mobile telephone 8 and may operate together with existing features of mobile telephone 8, such as a graphical user interface (GUI) 20 for producing menus, APIs (application programming interfaces) 22 with which to access applications 12 and a hardware interface 24.

Add-on user experience engine 9 may generate contextual menu elements 14 by parsing information in an instruction table 30 defining the structure of the menu elements. For example, instruction table 30 may be an XML structure and user experience engine 9 may include an interpreter to read instruction table 30 and to generate menus 14.

In accordance with a preferred embodiment of the present invention, authorized individuals may generate instruction table 30 on a web server 32. Thus, FIG. 2 shows a home computer 34 accessing server 32 over the web (shown as a cloud 36).

Web server 32 may enable authorized individuals to define the functionality of a set of mobile telephones 8. Thus, the authorized individuals may control the definitions of the user experience for a particular one or set of end-users. This may lock the user of the mobile telephone from accessing applications other than the applications provided from the menus.

These definitions are downloaded to a copy of instruction table 30 in mobile telephone 8 as shown via a communications network 38, such as the communication network of mobile telephone 8. Add-on user experience engine 9 running on each mobile telephone 8 may control the menus displayed there, and thus, may limit the enabled functionality.

In accordance with a preferred embodiment of the present invention, a user of mobile telephone 8 may define his/her display preferences, such as font type and size, colors, etc., and the preferences may be saved to the phone as well as to web server 32.

Instruction table 30 may be the common link in the system described in the current invention. Instruction table 30 may be created and defined on web server 32; a copy may be kept on the end-user device 8 which may be updated via a communication link; and add-on user experience engine 9 running on the end-user device (i.e. mobile telephone 8) may operate as the run-time environment which controls the end-user device's screen in accordance with table 30. Table 1 below shows a simplified instruction table 30 showing the nature of the records.

TABLE I

| Record | # of | |
|---|---|---|
| ID | Buttons | Content |
| M0 | 3 | “Call” M1, “Drugs” M16, “Help” P18 |
| M1 | 4 | “Ken” D202-443-4566, “Lucy” D202-343-4212, |
| | | “Others” M2, “Back” M0 |
| M2 | 4 | Children M3, Friends M4, Services M5, “Back” M0 |
| M3 | 5 | “Arthur” D434-222-9807, “Susan” |
| | | D233-324-7832, “Jane” D |
| M4 | 5 | |
| M5 | 4 | “Taxi” D202-4545, “Meals” D202-1122, |
| . . . | | |

To provide an example of the way such a table may be parsed and interpreted by user experience engine 9, the example table shows a number of ways in which the screen definition may be generated and the functions invoked from each button. Application 9 may either be an application running on top of an operating system (OS), which may be either largely or totally hidden from the end-user, or a special skin of the OS which performs the same function. In either case, the functionality presented to the end-user may be a closed list of functions defined by instruction table 30.

In this preferred embodiment, the Content field may list a series of pairs of data, shown delimited by commas by way of example, where the first item in each such pair may be the button-label, and the second may be the action to be performed if the end-user presses that button. Thus, in this example, the top level menu (M0) may be what the end-user sees when he switches on the device. This menu contains three buttons, one of which (labeled “Call”) may be the entry-point to the top-level menu of the dialing-out function (M1). Accordingly, if the end-user presses that button, the application then retrieves the M1 record and displays the screen according to the contents of that record. Similarly, there may be a hierarchy of menus dealing with issues of drug-taking compliance (starting with menu number M16). The “Help” button may not invoke a menu but rather a program (shown as “P”) or API that may be present on the end-user device (having the program number 18). For example, this program might issue a call to an emergency service while supplying the end-user's GPS coordinates. Note that at this level of the menu there may be no “Back” button as there may be nowhere to go back to.

To take the example further, if the end-user presses the Call button from the M0 menu above, then the application displays the buttons according to the M1 record; i.e. listing two names, “Ken” and “Lucy” (who would typically be the main care givers) and the option to call “Others”, or return (“Back”) to the previous menu. Note that the action associated with each of the names may be a dialing instruction (marked “D”) followed by the person's phone number. This action instruction may cause the end-user device to dial up that person according to the number given. The action associated with the “Back” button may be to present the menu as per instruction record M0. Note that if the user selects the “Others” button, this may cause the associated menu (which may be M2) to be displayed.

From the M2 menu in this example, the end-user may be further offered to choose between “Children”, Friends, “Services”; or “Back” in order to return to the M1 menu. Each of the options “Children”, Friends” or Services” may then cause the display of the appropriate menu (M3, M4, M5 respectively), so that the end-user can select a specific person to call or a service provider such as a local taxi service or food delivery service. For example, if the “Children” option were chosen, the names (and/or pictures) of the person's children may be shown in the buttons, and then the end-user may select one of these, causing a dialing action to that person to be initiated.

In this way, and as exemplified above, instruction table 30 may define a closed set of available functions, said functions and the menu-tree for accessing them being defined by the authorized individuals on server 32 which typically may not be the end-user. These functions may include dialing out, running a program on the end-user device (such as a simplified SMS application using pre-set templates), implementing a drug-reminder and follow-up algorithm, sending communications alerts (potentially together with GPS coordinates) to healthcare providers directly and/or the server and/or the authorized individuals, etc.

It will be appreciated that contextual menus 14 may provide “contextual bundles” where each menu 14 may package information of various types related to a single context, whether the context be health, or family, or sports, etc.

As will be apparent to one skilled in the art, mobile telephone 8 may continue to respond to telephony events, such as the receipt by the end-user device of an incoming telephone call or SMS. For example, in some embodiments, if there may be an incoming call, the screen display may show the number, name or picture of the person calling in, and button options enabling “Answer” or “Reject” options. If the person calling in (as identified by their number) may be among those people defined in the instruction table, then the name and/or picture of that person may be shown rather than the number.

It will be appreciated that each button may have content which changes, such as in response to an action. This may enable buttons to be reusable. Thus, a button for a dialer may say “Select” in one state and “Dial” in another state while a button for a camera may initially say “Take the Picture” but “Save” after the picture has been taken. Generally, the button may have a name, an icon or a database query.

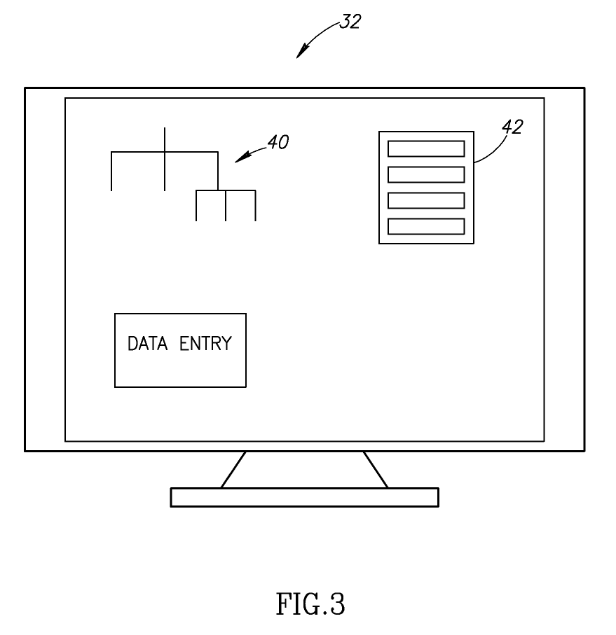

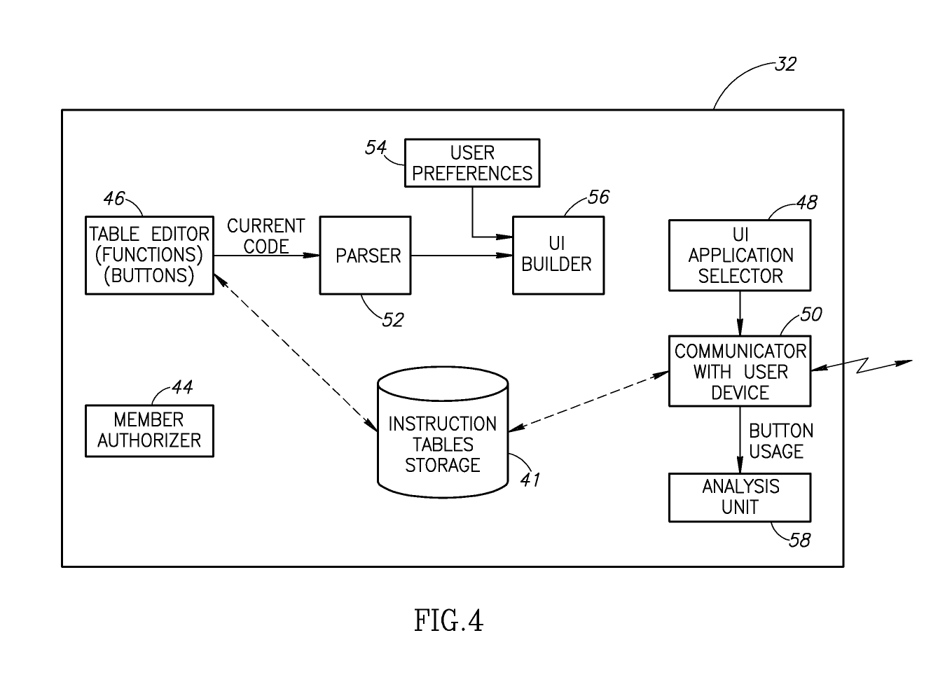

Reference is now made to FIG. 3 which illustrates the operation of web server 32 and to FIG. 4 which illustrates the elements of web server 32. Web server 32 may include an authorization sub-system 44 which relates authorized individuals or “members” to end-users of mobile telephones 8. This may include defining a login/password combination for each authorized individual that may be associated with a list of end-user(s) for which the individual may be authorized to provide data and definitions.

After login and selection of an end-user, the authorized individual may be presented with a representation of a hierarchy 40 of the current instruction menu for the selected end-user, stored in an instruction table storage unit 41. Web server 32 may have a table editor 46 which may provide functions enabling the authorized individual to alter the menu (adding or removing layers as necessary), store the names, pictures and phone numbers of the various contacts that the end-user may call (or receive calls from), and also choose other functions such as UI receiving applications 12 to activate that will be available from the end-user's menu. Examples of such applications may provide dialing and other messaging options (such as SMS), sending pre-packaged help messages to relatives or to healthcare organizations (potentially containing the end-user's GPS coordinates for immediate emergency pick-up), operating a remote-control link to medical or diagnostic devices in the user's environment (for example to perform an ECG and transmit the results), running a drug-reminder or management program located on the end-user device, etc.

The programs (“P”) that are defined by the authorized individual as “leaves” within the menu hierarchy may either be UI applications already present in the end-user device, or if not present there, may require downloading to the end-user device. In the latter case, web server 32 may comprise a UI application selector 48 to schedule these programs for OTA (over the air) downloading to the end-user device, via a communicator 50. In this way, according to another aspect of the present invention, there may be provided a method of distributing software to end-user devices on an “as-needed” or “as-ordered” basis.

As seen in FIG. 3, web server 32 may present a graphical user interface (GUI) 42 to the authorized individual of the menu screens. This may provide the authorized individual with visual feedback in that the menu hierarchy may be displayed together with the button functionality of the end-user device. GUI 42 may emulate the appearance of the end-user device, whose functionality may be dictated by the menu hierarchy so that the authorized individual may see exactly how the device GUI will appear to the end-user. The interface for the authorized individual includes elements whereby the authorized individual may select functions or programs to be run on the end-user device and may associate them with a specific button or “hot button” that invokes them.

To generate GUI 42, web server 32 may comprise a parser 52 (FIG. 4), a user preference unit 54 and a UI builder 56. Parser 52 may operate to read the current instruction table in table editor 46 to generate an initial menu and UI builder 56 may combine the initial menu with the information from user preferences unit 54 to generate the UI to be seen on mobile telephone 8. Units similar to units 52-56 may also form part of user experience engine 9.

Table editor 46 may enable the authorized individual to select one of UI applications 12 from one or more lists of functions presented on the screen of FIG. 3 which may, in turn, be “dragged” into association with a menu leaf by using the mouse. The lists may fall into a number of categories, for example: a list of functions or programs available to all end-users, a list available for premium users, etc. In some embodiments, the screen may have areas showing functions belonging to different categories in different screen locations.

In a further preferred embodiment, one of these lists may list UI applications 12 that have been bought or gifted by a third-party, for example by a friend or relative of the end-user. Such gifts may be purchased for a specific end-user, using order entry software known in the art; for example, a purchase over the Internet or a purchase by calling in a credit-card number to a sales representative. As described above, when such a US application 12 may be associated with a menu-leaf, it may be downloaded to the end-user device (unless already present there). Furthermore, when such a gifted application 12 may be first presented or used on the end-user's device, the name of the person gifting the application 12 or any other suitable message may be displayed on the end-user screen, such that it will be clear to the end-user that he or she may be the recipient of a gift. Thus, in accordance with another aspect of the invention, there may be provided a method of sending a gift to an end-user device. It will be clear to one skilled in the art that these actions performed by an authorized individual could equally well be performed by a software agent under control of a remote user.

At any point during the definition stage described above, the authorized user may save and/or mark for download the updated records, for transmission to the end-user device, via communicator 50. In some embodiments, this communications process may be transparent to the end user, and a special SMS or OTA signal to the end-user device may cause the update to occur. In other embodiments, not all the instruction table records need to be updated. By judicious use of time-stamping of the record in the table, only the updated records (relative to what was in the instruction table in the end-user device) need be transferred. As will be clear to one skilled in the art, the data and/or instructions in instruction table 30 do not need to be physically held within one table but may be split among a number of separate tables, using relations between the tables as may be known in the art.

In accordance with some embodiments, mobile telephone 8 may store a history of button usage, which may be downloaded to web server 32 for storage and analysis via communicator 50. The analysis may be carried out selectively by the authorized individual or automatically by an analysis unit 58 of web server 32. In some embodiments, the analysis may serve to update the button functionality. For example, if it may be found that a button lower down in the menu hierarchy may be used more frequently than one that may be higher up, the relative positions in the menu hierarchy may be changed automatically so that, when next downloaded by the end-user device, the more frequently-used button will be appear higher in the menu hierarchy.

Web server 32 may be responsive to the analysis for sending an alert to one of the authorized individuals. By such means, a caregiver may be alerted if a patient, on behalf of whom the caregiver may be authorized, dials the emergency services.

The remote-control button may be configured to communicate with a warning device located in the authorized individual's home or other premises.

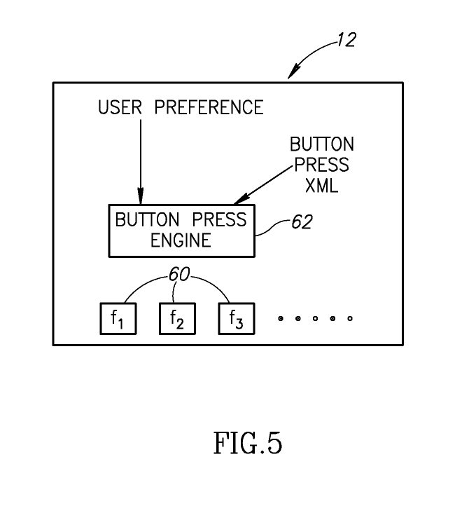

Reference is now made to FIG. 5, which illustrates an exemplary UI application 12. UI applications 12 typically incorporate a standard cellphone “app”, such as a dialer, a clock, a GPS, etc and provide such applications with the ability to receive parameters from an external program.

As can be seen in FIG. 5, UI application 12 may comprise a plurality of functions 60, such as may be standard for the type of application, and a button press engine 62 which may receive user preferences and button press code, such as a section of XML code, from user experience engine 9 whenever the associated button is pressed or swiped. Button press engine 60 may activate one function 60 in response to the received button press code.

For example, UI application 12 may incorporate a phone dialer. Thus, functions 60 may be the various functions of a phone dialer, such as receiving phone numbers, and connecting to the phone line, handling the various tones on the line, etc. UI application 12 may add button press engine 60 to such a dialer, to enable the dialer to receive parameters, such as a particular phone number. It will also be understood that the system according to the invention may be a suitably programmed machine such as a computer or other device having a processing unit capable of operating in accordance with a stored instruction set. Likewise, the invention contemplates a machine-readable program being readable by a machine for executing the method of the invention. The invention further contemplates a machine-readable memory tangibly embodying a program of instructions executable by the machine for executing the method of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A mobile device comprising:
a storage unit to store an instruction table, said instruction table defining at least one menu which is associated with multiple parameter receiving applications of said mobile device; and
an add-on user experience engine to parse said instruction table and to display said at least one menu with at least one button, wherein each button is configured to activate one of said applications with parameters for said application as defined in said instruction table.

2. The device according to claim 1 and also comprising a downloader to receive said instruction table from a web server accessible to an authorized individual.

3. The device according to claim 1, wherein each of the buttons is responsive to said instructions for operating as any one in the group of: a menu button, a telephone dialing button calling a specific number, an information request button an emergency call button and a remote-control button.

4. The device according to claim 3 and also comprising a button unit to store a history of usage of said buttons.

5. The device according to claim 4 and also comprising an uploader to upload said history to said web server for analysis.

6. The device according to claim 3 wherein said remote-control button is configured to communicate with a warning device located in the premises of said authorized individual.

7. The device according to claim 1 wherein said instruction table defines a menu hierarchy arranged in a tree-structure defining multiple records, each of which defines a stage in the menu tree, with each button shown serving either to call another branch of the menu record, or to activate an application associated with that button.

8. The device according to claim 7, wherein said user experience engine comprises means to access and interpret a master record defining the top level menu on actuation of said mobile device.

9. The device according to claim 7, wherein the master record defines a number of hot buttons for which pre-stored legends or icons are shown on actuation of said mobile device.

10. The device according to claim 9, wherein at least one of the hot buttons serves to allow navigation through the menu tree.

11. The device according to claim 1 and wherein each said application comprises an engine to receive at least button press code providing parameters to internal functions of said application.

12. A user experience menu definer implementable on a web server, the definer comprising:
an authorizer to provide an authorized individual with access to information about a mobile device of another person;
table defining means to generate an instruction table from input of said authorized individual, said instruction table defining at least one menu which is associated with multiple parameter receiving applications of said mobile device, said table defining buttons per menu, wherein each button is configured to activates one of said applications with parameters for said application.

13. The definer according to claim 12 and also comprising a communicator to receive a history of usage of said buttons to a database server.

14. The definer according to claim 13 and also comprising an analyzer to analyze said history.

15. The definer according to claim 14, wherein said analyzer comprises a button updater to update a functionality of said buttons.

16. The definer according to claim 15 and wherein said communicator comprises a unit to send an alert to one of the authorized individuals based on output of said analyzer.

17. The definer according to claim 13 wherein said table of instructions includes a menu hierarchy arranged in a tree-structure defining multiple records, each of which defines a stage in the menu tree, so that when uploaded by said communicator to said mobile device each button shown thereby serves either to call another branch of the menu record, or activate a function associated with that button.

18. The definer according to claim 17, wherein said database server stores for each mobile device a respective master record defining a top level menu to be accessed and interpreted on actuation of said mobile device.

19. The definer according to claim 18, wherein the master record defines a number of hot buttons for which pre-stored legends or icons are shown on the touch-screen on actuation of said mobile device.

20. The definer according to claim 19, wherein at least one of the hot buttons serves to allow navigation through the menu tree.

21. A method for a mobile device, the method comprising:
storing an instruction table, said instruction table defining at least one menu which is associated with multiple parameter receiving applications of said mobile device
parsing said instruction table; and
displaying said at least one menu with at least one button, wherein each button is configured to access one of said applications with parameters for said application as defined in said instruction table.

22. The method according to claim 21 and also comprising receiving said instruction table from a web server accessible to an authorized individual.

23. The method according to claim 21, wherein each of the buttons is responsive to said instructions for operating as any one in the group of: a menu button, a telephone dialing button calling a specific number, an information request button an emergency call button and a remote-control button.

24. The method according to claim 23 and also comprising storing a history of usage of said buttons.

25. The method according to claim 24 and also comprising uploading said history to said web server for analysis.

26. The method according to claim 23 and also comprising configuring said remote-control button to communicate with a warning method located in the premises of said authorized individual.

27. The method according to claim 21 wherein said instruction table defines a menu hierarchy arranged in a tree-structure defining multiple records, each of which defines a stage in the menu tree, with each button shown serving either to call another branch of the menu record, or to activate an application associated with that button.

28. The method according to claim 27, and also comprising accessing and interpreting a master record defining the top level menu on actuation of said mobile method.

29. The method according to claim 27, wherein the master record defines a number of hot buttons for which pre-stored legends or icons are shown on actuation of said mobile method.

30. The method according to claim 29, wherein at least one of the hot buttons serves to allow navigation through the menu tree.

31. The method according to claim 21 and comprising, in each said application, receiving at least button press code providing parameters to internal functions of said application.

32. The method according to claim 22, further including:
checking whether an application that is defined by the authorized individual as a “leaf” within the menu hierarchy is already present in the mobile method; and
if the application is not already present in the mobile method, scheduling for over-the-air downloading to the mobile method.

33. The method according to claim 32, further including associating with the application a message identifying the application as a gift and together with an identity of a purchaser of said gift so that when the application is downloaded to the mobile method, information including said identity is presented.

34. A method implementable on a web server, the method comprising:
providing an authorized individual with access to information about a mobile device of another person;
from instructions of said authorized individual, generating an instruction table defining at least one menu which is associated with multiple applications of said mobile device, said table defining buttons per menu, wherein each button is configured to activate one of said applications with parameters for said application.

35. The method according to claim 34 and also comprising receiving a history of usage of said buttons to a database server.

36. The method according to claim 35 and also comprising analyzing said history.

37. The method according to claim 36, and also comprising updating a functionality of said buttons.

38. The method according to claim 37 and also comprising sending an alert to one of the authorized individuals based on output of said analysis.

39. The method according to claim 34 wherein said table of instructions includes a menu hierarchy arranged in a tree-structure defining multiple records, each of which defines a stage in the menu tree, so that when uploaded to said mobile device each button shown thereby serves either to call another branch of the menu record, or activate a function associated with that button.

40. The method according to claim 39, and also comprising storing for each mobile device a respective master record defining a top level menu to be accessed and interpreted on actuation of said mobile device.

41. The method according to claim 40, wherein the master record defines a number of hot buttons for which pre-stored legends or icons are shown on the touch-screen on actuation of said mobile device.

42. The method according to claim 41, wherein at least one of the hot buttons serves to allow navigation through the menu tree.

43. A mobile device comprising:
a processor coupled to a memory for operating in accordance with communications and human-interface software stored in the memory,
a touch-screen interface coupled to the processor and responsive to said software for displaying a virtual keypad having programmable buttons, at least some of which are configured to operate in accordance with stored instructions that are downloadable to the device so as to provide a respective software function,
wherein the instructions includes a menu hierarchy arranged in a tree-structure defining multiple records, each of which defines a stage in the menu tree, with each button shown serving either to call another branch of the menu record, or to activate a function associated with that button.
